(19) United States
(12) Patent Application Publication
(10) Pub. No.: US 2011/0062304 A1
(43) Pub. Date: Mar. 17, 2011

(54) DISPLAY POSITIONING MECHANISM WITH DIFFERENT TYPES OF HINGES AND RELATED DISPLAY DEVICE

(76) Inventors: Sung-Yu Hsieh, Taipei Hsien (TW); Wen-Chin Wu, Taipei Hsien (TW); Tin-Jong Shiue, Taipei Hsien (TW); I-Ting Chiang, Taipei Hsien (TW); Chang-Chih Han, Taipei Hsien (TW)

(21) Appl. No.: 12/875,121

(22) Filed: Sep. 2, 2010

(30) Foreign Application Priority Data
Sep. 16, 2009 (TW) 098131212

(51) Int. Cl. F16M 11/16

(52) U.S. Cl. 248/372.1

(57) ABSTRACT

A display positioning mechanism includes two hinge modules connected to two ends of a supporting component. Each hinge module includes a preload control washer whereon a constraining structure is formed. Each hinge module further includes a loading component. A fixing end of the loading component is fixed on an end of the supporting component. When an angle of a display and a supporting plane is within a first range, the loading component is preloaded and a free end of the loading component contacts against an end of the constraining structure so as to provide a torque in a first direction to the supporting component. When the angle of the display and the supporting plane is within a second range, the free end of the loading component does not contact against the end of the constraining structure so that the loading component can not provide the torque to the supporting component.

### BACKGROUND OF THE INVENTION

1. Field of the Invention

The present invention relates to a display positioning mechanism with different types of hinges and a related display device, and more particularly, to a display positioning mechanism with a vertical stand hinge and a frame stand hinge and a related display device.

2. Description of the Prior Art

In recent years, all in one PC plays an increasingly important role in the market. However, a stand type of the all in one PC uses a conventional stand as usual without revolution. For example, a frame stand and a vertical stand are the most popular types. As the same as a conventional liquid crystal display, a consumer has to decide a type of the stand before purchasing the all in one PC. In addition, the VESA-hold is not utilized to be a standard specification by all manufacturers. Therefore, it is difficult to change the type of the stand of the conventional all in one PC, such as the frame stand, the vertical stand, and so on. Please refer to FIG. 1. FIG. 1 is a structural diagram of a vertical stand mechanism 10 in the prior art. The vertical stand mechanism 10 includes a display 12 fixed on a central axle 16 of a base 14. A weight of the display 12 loads onto the base 14 and a table whereon the base 14 is positioned via the central axle 16. Besides, the display 12 can be rotated relative to the central axle 16 within a specific range. In order to force economically and uniformly, a torsional spring is installed on the central axle 16. Because a moment generated by the weight of the display 12 decreases an angle θ between the display 12 and the base 14, a torque provided by the torsional spring has to increase the angle θ so as to counteract the moment generated by the weight of the display 12 for saving an effort.

In addition, please refer to FIG. 2. FIG. 2 is a structural diagram of a frame stand mechanism 20 in the prior art. The frame stand mechanism 20 includes a display 22 and a brace 24 for supporting the display 22. A front edge of the display 22 and the brace 24 contact against a table, which means there are two contacting points between the table and the frame stand mechanism 20. An elevation angle of the display 22 of the frame stand mechanism 20 is adjustable. The adjusting mechanism includes two ways. One is moving a lower edge of the display 22 relative to the table and fixing the brace 24 on the table so as to adjust the elevation angle of the display 22. The other is moving the brace 24 relative to the table and fixing the display 22 on the table. Because a weight of the display 22 drives the brace 24 to move backward, a central axle 26 connected between the display 22 and the brace 24 provides a frictional moment to prevent the brace 22 from moving backward. A torsional spring can be installed on the central axle 26 for retrieving the brace 24 automatically for decreasing the angle between the display 22 and the brace 24, so that a user can operate the frame stand mechanism 20 with one hand conveniently. Because a moment generated by the weight of the display 22 increases an angle θ between the display 22 and the brace 24, a torque provided by the torsional spring decreases the angle θ so as to reduce the frictional moment for saving an effort.

As mentioned above, a hinge structure of the vertical stand mechanism is opposite to a hinge structure of the frame stand mechanism, which means the torque provided by the torsional spring in the conventional vertical stand mechanism is opposite to the torque provided by the torsional spring in the conventional frame stand mechanism. There is no mechanism capable of combining the vertical stand mechanism with the frame stand mechanism in the market. The vertical stand mechanism and the frame stand mechanism have their operational limitation, respectively. For example, the operational range of the angle θ of the conventional vertical stand mechanism is between −5 degree and 20 degree, and the operational range of the angle θ of the conventional frame stand mechanism is between 20 degree and 62 degree. As the conventional vertical stand mechanism shown in FIG. 1, an elevation angle α of the display 12 is equal to the angle θ (alternate-interior angle) substantially. As the conventional frame stand mechanism shown in FIG. 2, a triangle formed by the display 22, the brace 24, and the supporting plane is similar to an isosceles triangle, so that an elevation angle α is equal to half of the angle θ substantially. If the range of the elevation angle of the vertical stand is demanded between −5 degree and 20 degree and the range of the elevation angle of the frame stand is demanded between 15 degree and 30 degree, it is acceptable to set the range of the angle θ of the vertical stand between −5 degree and 20 degree and the range of the angle θ of the frame stand between 25 degree and 62 degree. Therefore, different stands can position the display in different angles, and design of a mechanism capable of combining the vertical stand mechanism with the frame stand mechanism can promote competitiveness in the market effectively.

### SUMMARY OF THE INVENTION

The present invention provides a display positioning mechanism with different types of hinges and a related display device for solving above drawbacks.

According to the claimed invention, a display positioning mechanism with different types of the hinges includes a supporting component connected to a display and for supporting the display, a first hinge module connected to a first end of the supporting component, and a second hinge module connected to a second end of the supporting component. The first hinge module includes a first preload control washer whereon a first constraining structure is formed, and a first loading component, a fixing end of the first loading component being fixed on the first end of the supporting component, the first loading component providing a torque in a first direction to the supporting component when an angle of the display and a supporting plate is within a first range, and the first loading component not providing the torque to the supporting component when the angle of the display and the supporting plane is within a second range different from the first range. The second hinge module includes a second preload control washer whereon a second constraining structure is formed, and a second loading component, a fixing end of the second loading component being fixed on the second end of the supporting component, the second loading component not providing the torque to the supporting component when the angle of the display and the supporting plate is within the first range, and the second loading component providing a torque in a second direction opposite to the first direction to the supporting component when the angle of the display and the supporting plane is within the second range.

According to the claimed invention, a display positioning mechanism includes a supporting component connected to a display and for supporting the display, a first constraining structure and a second constraining structure being respectively formed on a first end and a second end of the supporting component, a first hinge module connected to the first end of the supporting component, and a second hinge module connected to the second end of the supporting component. The first hinge module includes a first preload control washer, and a first loading component, a fixing end of the first loading component being fixed on the first preload control washer, the first loading component providing a torque in a first direction to the supporting component when an angle of the display and a supporting plate is within a first range, and the first loading component not providing the torque to the supporting component when the angle of the display and the supporting plane is within a second range different from the first range. The second hinge module includes a second preload control washer, and a second loading component, a fixing end of the second loading component being fixed on the second preload control washer, the second loading component not providing the torque to the supporting component when the angle of the display and the supporting plate is within the first range, and the second loading component providing a torque in a second direction opposite to the first direction to the supporting component when the angle of the display and the supporting plane is within the second range.

According to the claimed invention, a display device includes a display, a base for supporting the display on a supporting plane, and a display positioning mechanism connected to the display and the base for positioning the display on the supporting plane. The display positioning mechanism includes a supporting component connected to the display for supporting the display, a first hinge module connected to a first end of the supporting component, and a second hinge module connected to a second end of the supporting component. The first hinge module includes a first preload control washer whereon a first constraining structure is formed, and a first loading component, a fixing end of the first loading component being fixed on the first end of the supporting component, the first loading component providing a torque in a first direction to the supporting component when an angle of the display and the supporting plate is within a first range, and the first loading component not providing the torque to the supporting component when the angle of the display and the supporting plane is within a second range different from the first range. The second hinge module includes a second preload control washer whereon a second constraining structure is formed, and a second loading component, a fixing end of the second loading component being fixed on the second end of the supporting component, the second loading component not providing the torque to the supporting component when the angle of the display and the supporting plate is within the first range, and the second loading component providing a torque in a second direction opposite to the first direction to the supporting component when the angle of the display and the supporting plane is within the second range.

According to the claimed invention, a display device includes a display, a base for supporting the display on a supporting plane, and a display positioning mechanism connected to the display and the base for positioning the display on the supporting plane. The display positioning mechanism includes a supporting component connected to the display for supporting the display, a first constraining structure and second constraining structure being respectively formed on a first end and a second end of the supporting component, a first hinge module connected to the first end of the supporting component, and a second hinge module connected to a second end of the supporting component. The first hinge module includes a first preload control washer, and a first loading component, a fixing end of the first loading component being fixed on the first preload control washer, the first loading component providing a torque in a first direction to the supporting component when an angle of the display and the supporting plate is within a first range, and the first loading component not providing the torque to the supporting component when the angle of the display and the supporting plane is within a second range different from the first range. The second hinge module includes a second preload control washer, and a second loading component, a fixing end of the second loading component being fixed on the second preload control washer, the second loading component not providing the torque to the supporting component when the angle of the display and the supporting plate is within the first range, and the second loading component providing a torque in a second direction opposite to the first direction to the supporting component when the angle of the display and the supporting plane is within the second range.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structural diagram of a vertical stand mechanism in the prior art.

FIG. 2 is a structural diagram of a frame stand mechanism in the prior art.

FIG. 3 and FIG. 4 are diagrams of a display device in different modes according to a preferred embodiment of the present invention, respectively.

FIG. 5 is a schematic drawing of a display positioning mechanism according to the preferred embodiment of the present invention.

FIG. 6 is an exploded diagram of the display positioning mechanism according to the preferred embodiment of the present invention.

FIG. 7 is an enlarged diagram of a first frictional torque control washer, a second frictional torque control washer, and a separated washer according to the preferred embodiment of the present invention.

FIG. 8 is a diagram of a first loading component and a second loading component respectively positioned inside a first constraining structure of a first preload control washer and a second constraining structure of a second preload control washer in different states according to the preferred embodiment of the present invention.

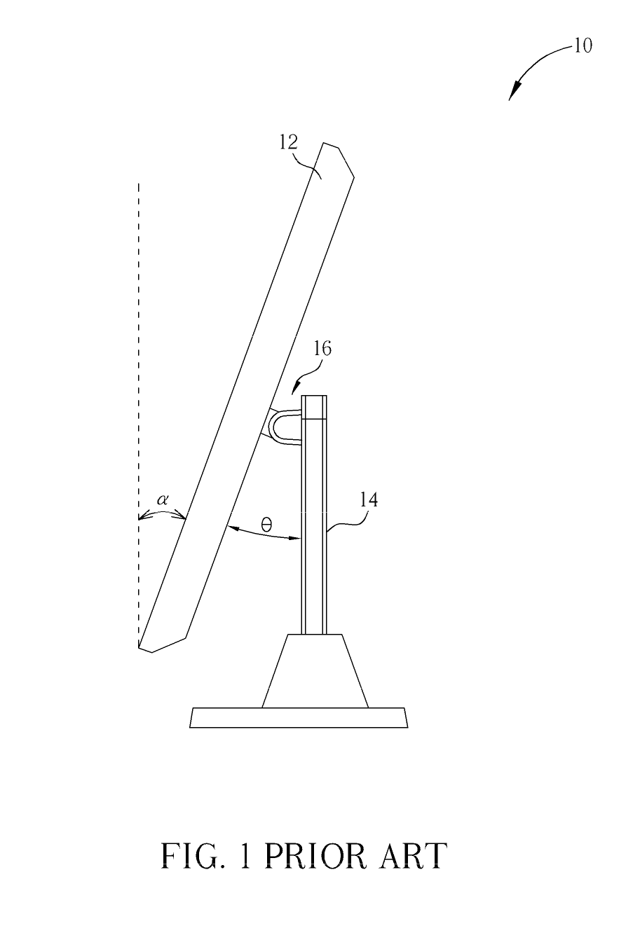

### DETAILED DESCRIPTION

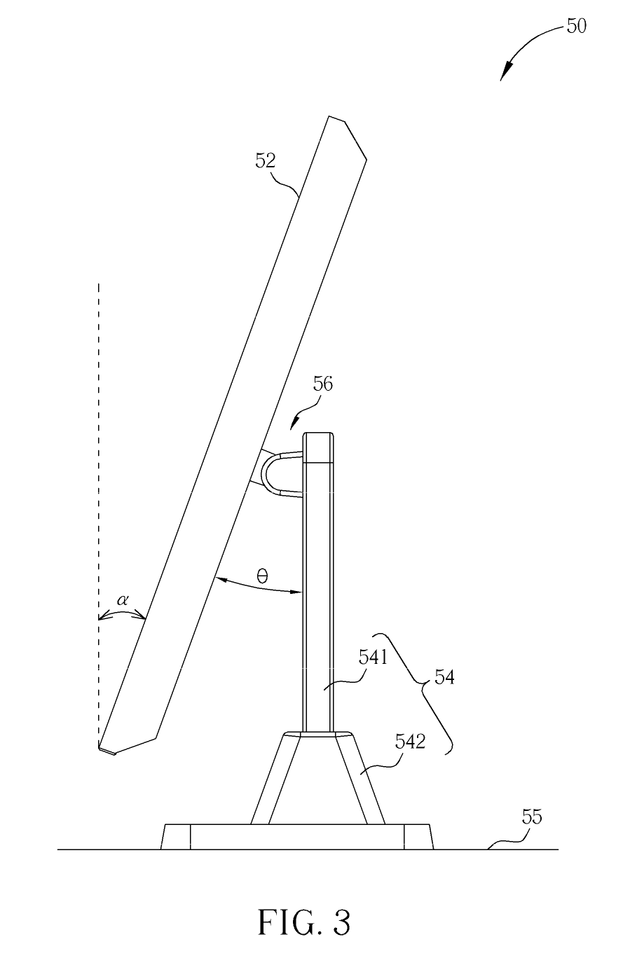

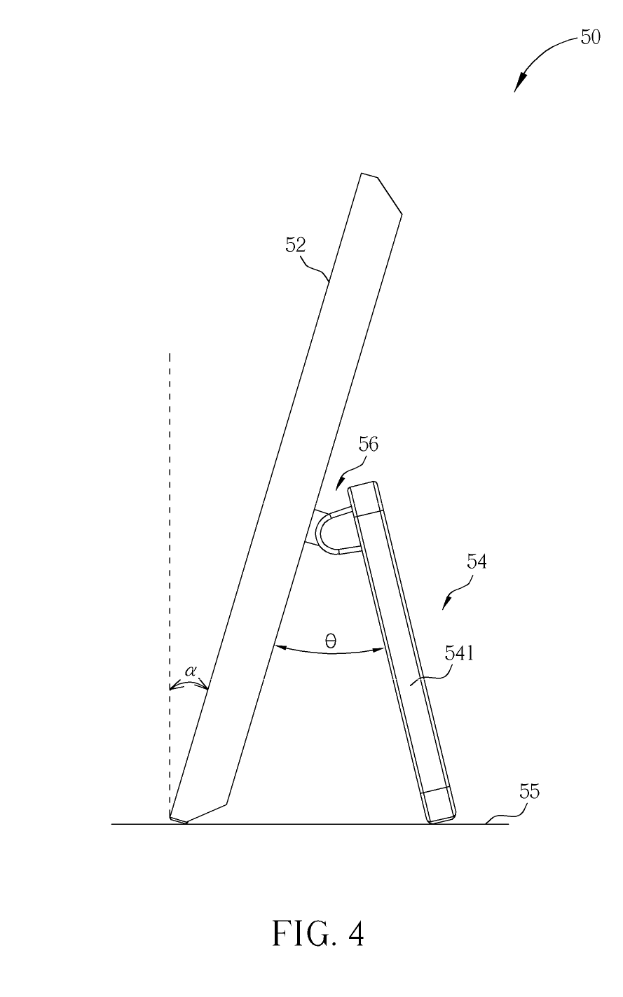

Please refer to FIG. 3 and FIG. 4. FIG. 3 and FIG. 4 are diagrams of a display device 50 in different modes according to a preferred embodiment of the present invention, respectively. The display device 50 can be a liquid crystal display, an all in one PC, and so on. The display device 50 includes a display 52, a base 54 for supporting the display 52 on a supporting plane 55, and a display positioning mechanism 56 connected to the display 52 and the base 54 for positioning the display 52 on the supporting plane 55. The base 54 includes a brace 541 and a stand 542 connected to the brace 541 in a detachable manner. As shown in FIG. 3, when the display device 50 is in a vertical stand mode, the stand 542 is combined with the brace 541, and the brace 541 can support the display 52 on the supporting plane 55. As shown in FIG. 4, when the display device 50 is in a frame stand mode, the stand 542 is disassembled from the brace 541, which means the brace 541 supports the display 52 on the supporting plane 55 directly. As the display device 50 in the vertical stand mode shown in FIG. 3, an elevation angle α of the display 52 is equal to an angle θ (alternate-interior angle) substantially. As the display device 50 in the frame stand mode shown in FIG. 4, a triangle formed by the display 52, the brace 541, and the supporting plane 55 is similar to an isosceles triangle substantially, so that the elevation angle α is equal to half of an angle θ substantially.

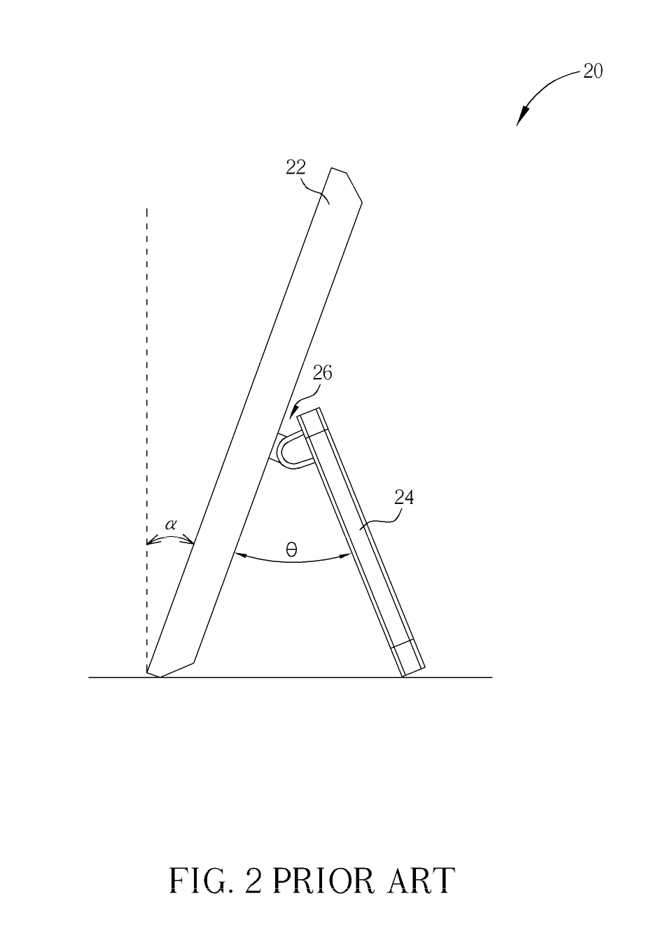

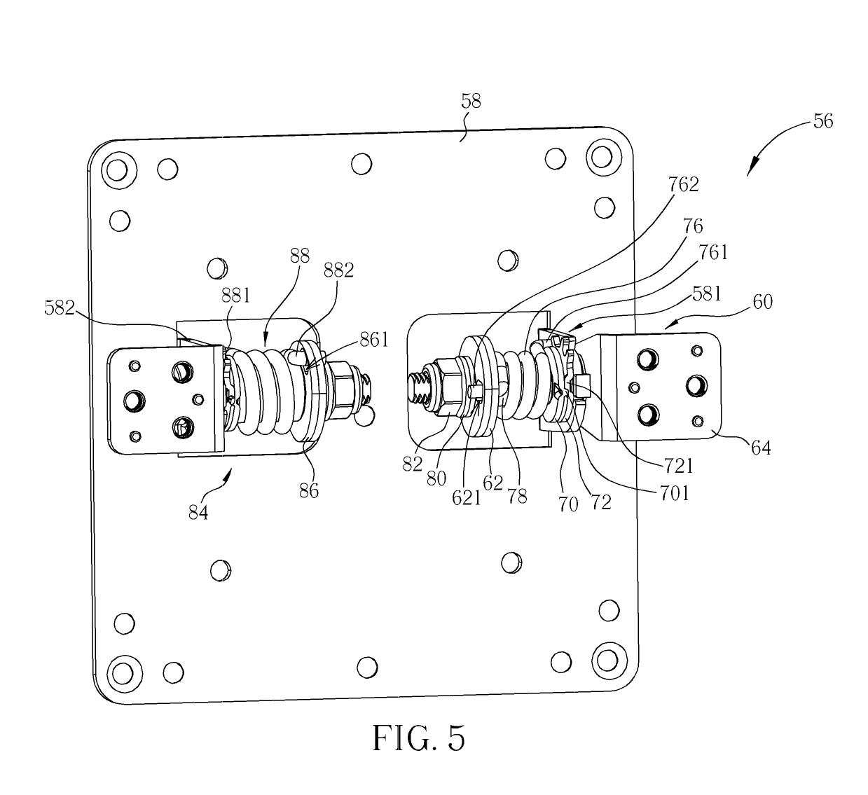

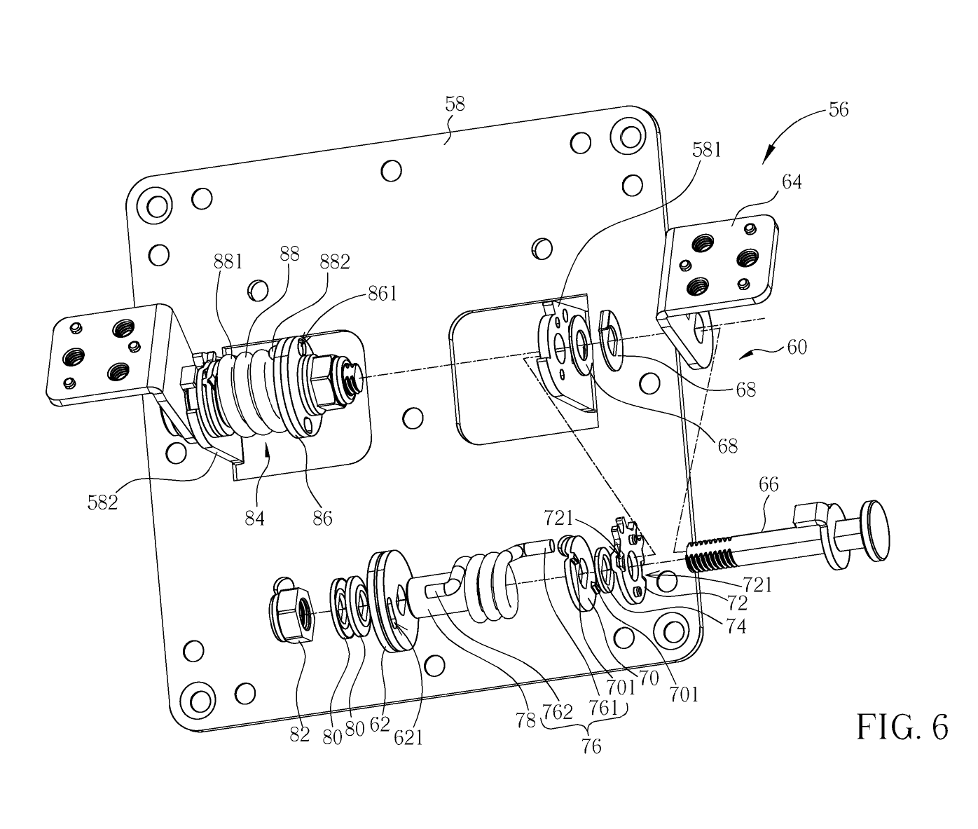

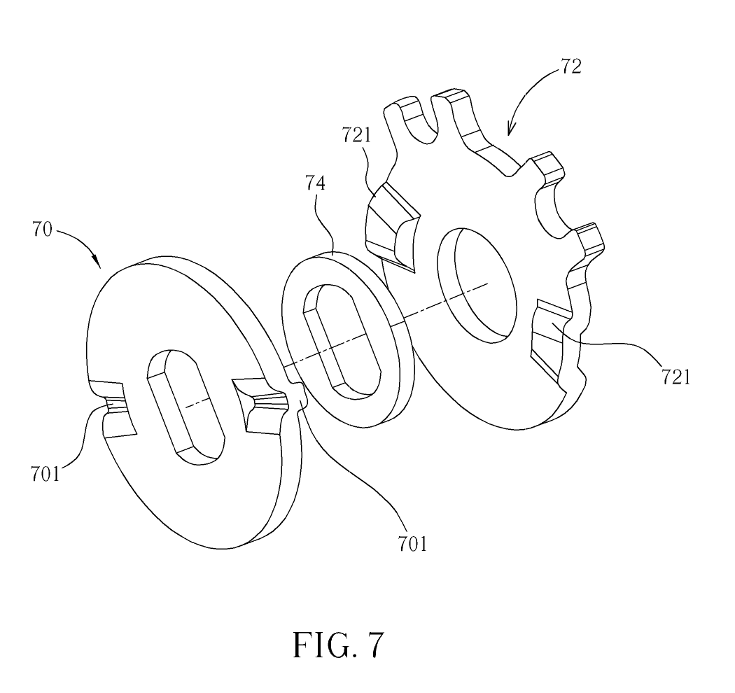

Please refer to FIG. 3 to FIG. 6. FIG. 5 is a schematic drawing of the display positioning mechanism 56 according to the preferred embodiment of the present invention. FIG. 6 is an exploded diagram of the display positioning mechanism 56 according to the preferred embodiment of the present invention. The display positioning mechanism 56 includes a supporting component 58 connected to the display 52 shown in FIG. 2 and FIG. 3 and for supporting the display 52. The supporting component 58 can be a punching thin plate. The display positioning mechanism 56 further includes a first hinge module 60 connected to a first end 581 of the supporting component 58. The first hinge module 60 includes a first preload control washer 62 whereon a first constraining structure 621 is formed. The first constraining structure 621 can be an arc slot. The first hinge module 60 further includes a connecting plate 64 for connecting to the base 54 shown in FIG. 2 and FIG. 3. The first hinge module 60 further includes a central axle 66 passing through the first end 581 of the supporting component 58. The first hinge module 60 further includes at least one wear-resisting washer 68 sheathed on the central axle 66 and installed between the connecting plate 64 and the first end 581 of the supporting component 58 for preventing the first end 581 of the supporting 58 from being worn when the first end 581 of the supporting 58 rotates relative to the connecting plate 64. The first hinge module 60 further includes a first frictional torque control washer 70 sheathed on the central axle 66. At least one first protruding portion 701 is formed on the first frictional torque control washer 70. The first protruding portion 701 can be a protrusion. The first hinge module 60 further includes a second frictional torque control washer 72 sheathed on the central axle 66 and fixed on the first end 581 of the supporting component 58 in a rotatable manner relative to the first frictional torque control washer 70. At least one second protruding portion 721 is formed on the second frictional torque control washer 72. The first hinge module 60 further includes a separated washer 74 sheathed on the central axle 66 and installed between the first frictional torque control washer 70 and the second frictional torque control washer 72 so as to control a distance of the first frictional torque control washer 70 and the second frictional torque control washer 72. Please refer to FIG. 7, FIG. 7 is an enlarged diagram of the first frictional torque control washer 70, the second frictional torque control washer 72, and the separated washer 74 according to the preferred embodiment of the present invention.

Please refer to FIG. 5 and FIG. 6. The first hinge module 60 further includes a first loading component 76. The first loading component 76 can be a torsional spring. A fixing end 761 of the first loading component 76 is fixed on the first end 581 of the supporting component 58. For example, the fixing end 761 can be inserted into a hole on the first end 581. A movable end 762 of the first loading component 76 passes through the first constraining structure 621 of the first preload control washer 62. The first hinge module 60 further includes a sleeve 78 sheathed on the central axle 66 and contacting the second frictional torque control washer 72 and the first preload control washer 62. The first hinge module 60 further includes at least one elastic washer 80 sheathed on the central axle 66 and installed on a side of the first preload control washer 62. When the first protruding portion 701 of the first frictional torque control washer 70 contacts the second protruding portion 721 of the second frictional torque control washer 72, the second frictional torque control washer 72 is pushed along an axial direction of the central axle 66 to push the sleeve 78, so that the first preload control washer 62 contacts the elastic washer 80 tightly. The first hinge module 60 further includes a screw nut 82 installed on a side of the elastic washer 80 for screwing an end of the central axle 66 so as to assemble the above-mentioned components on the central axle 66.

The display positioning mechanism 56 further includes a second hinge module 84 connected to a second end 582 of the supporting component 58. Basically, a structure of the second hinge module 84 is similar with a structure of the first hinge module 60. The different components are introduced as below, and the identical components are omitted to introduce herein for simplicity. The second hinge module 84 includes a second preload control washer 86 whereon a second constraining structure 861 is formed. The second constraining structure 861 can be an arc slot. The second hinge module 86 further includes a second loading component 88. The second loading component 88 can be a torsional spring. A fixing end 881 of the second loading component 88 is fixed on the second end 582 of the supporting component 58. For example, the fixing end 881 can be inserted into a hole on the second end 582. A movable end 882 of the second loading component 88 passes through the second constraining structure 861 of the second preload control washer 86.

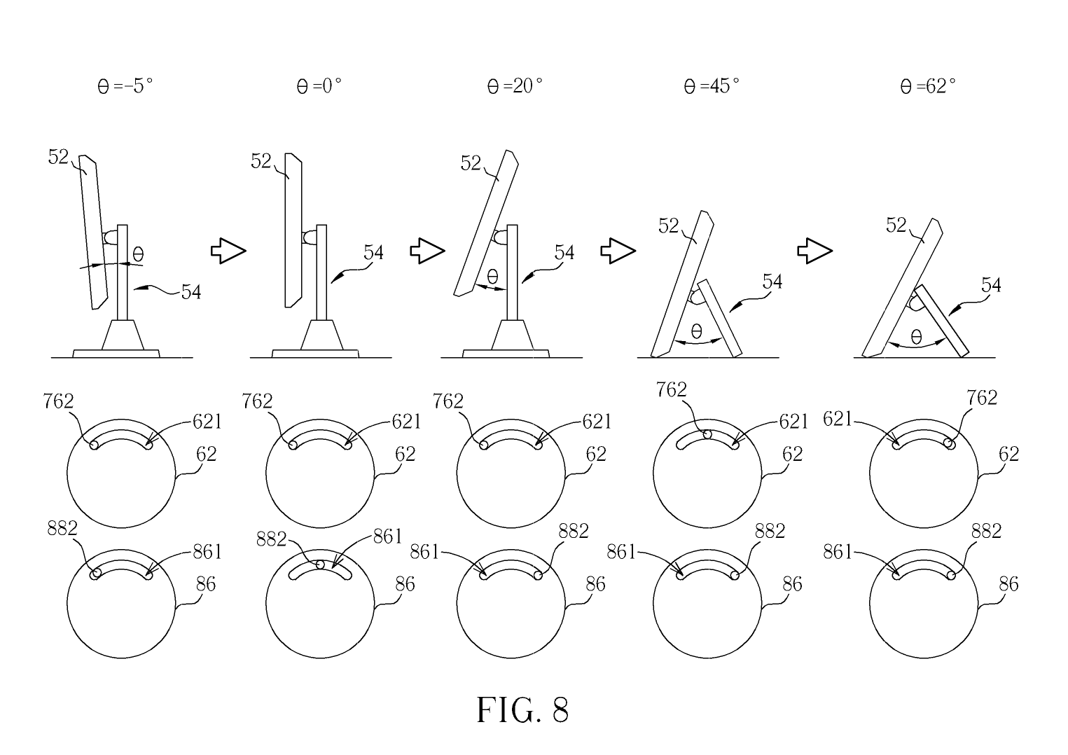

Because a setting direction of the first loading component 76 is opposite to a setting direction of the second loading component 88, the torque provided by the first loading component 76 is opposite to the torque provided by the second loading component 88. In the present invention, the first hinge module 60 and the second hinge module 84 can be the vertical stand hinge mechanism and the frame stand hinge mechanism, respectively. The first hinge module 60 and the second hinge module 84 can further be the frame stand hinge mechanism and the vertical stand hinge mechanism, respectively. Please refer to FIG. 8. FIG. 8 is a diagram of the first loading component 76 and the second loading component 88 respectively positioned inside the first constraining structure 621 of the first preload control washer 62 and the second constraining structure 861 of the second preload control washer 86 in different states according to the preferred embodiment of the present invention. For example, when the angle θ of the display 52 and the brace 541 is within a first range, as the first range in the vertical stand mode substantially within the range of −5 degree and 20 degree shown in FIG. 3, the first loading component 76 is preloaded and the movable end of the first loading component 76 contacts against an end of the first constraining structure 621. When the display 52 is rotated within the first range, the first loading component 76 is preloaded, and the movable end 762 of the first loading component 76 always contacts against the end of the first constraining structure 621. Therefore, the first loading component 76 can provide a torque in a first direction to the first preload control washer 62 and can transmit the torque to the supporting component 58. Because the moment generated by the weight of the display 52 decreases the angle θ, as the display device 50 is in the vertical stand mode shown in FIG. 3, the torque provided by the first loading component 76 increases the angle θ so as to counteract the moment generated by the weight of the display 52 for saving an effort. Meanwhile, the first hinge module 60 is utilized in the vertical stand mode. When the angle of the display 52 and the supporting plane 55 is within the first range, a movable end 882 of the second loading component 88 is slid relative to the second constraining structure 861 and does not contact against an end of the second constraining structure 861 of the second preload control washer 86, which means the second loading component 88 is released, so that the second loading component 88 can not provide the torque to the supporting component 58. As mentioned above, when the angle of the display 52 and the supporting plane 55 is within the first range, which means the display device 50 is in the vertical stand mode, only the first loading component 76 of the first hinge module 60 provides the torque to the supporting component 58, the second loading component 88 of the second hinge module 84 is released and does not provide the torque to the supporting component 58, so that the torque generated by the first loading component 76 is not counteracted by the second loading component 88.

When the angle θ of the display 52 and the brace 541 is within a second range different from the first range, as the display device 50 is in the frame stand mode substantially within the range of 20 degree and 62 degree shown in FIG. 4, the first loading component 76 is not preloaded, and the movable end of the first loading component 76 is slid relative to the first constraining structure 621 and does not contact against the end of the first constraining structure 621 of the first preload control washer 62, which means the first loading component 76 is released, so that the first loading component 76 does not provide the torque to the supporting component 58. Meanwhile, the second loading component 88 is preloaded, the movable end 882 of the second loading component 88 contacts against the end of the second constraining structure 861 of the second preload control washer 86, and the second loading component 88 is preloaded when the display 52 is rotated within the second range, so that the movable end 882 of the second loading component 88 always contacts against the end of the second constraining structure 861. Therefore, the second loading component 88 can provide a torque in a second direction opposite to the first direction to the second preload control washer 86 and can transmit the torque to the supporting component 58. Because the moment generated by the weight of the display 52 increases the angle θ, as the display device 50 in the frame stand mode shown in FIG. 4, the torque provided by the second loading component 88 decreases the angle θ. That is to say, the second loading component 88 can be utilized to counteract the moment generated by the weight of the display 52, so that the brace 541 can be retrieved automatically by one hand when the user reduces the elevation angle of the display 52. Meanwhile, the second hinge module 84 is utilized in the frame stand mode. As mentioned above, when the angle of the display 52 and the supporting plane 55 is within the second range, which means the display device 50 is in the frame stand mode, only the second loading component 88 of the second hinge module 84 provides the torque to the supporting component 58, and the first loading component 76 of the first hinge module 60 is released and does not provide the torque to the supporting component 58, so that the torque generated by the second loading component 88 is not counteracted by the first loading component 76. In addition, the first range and the second range can be overlapped or not. For example, although an effect of the loading component is reduced when the first range and the second range are overlapped, the overlapped range is still practicable when the display is not bowed without an external force and the pulling/pushing force is acceptable. Besides, the incontinuous first and second ranges are also practicable when a preload angle of the loading component can provide enough torsion to retrieve the brace automatically.

In addition, the display positioning mechanism 56 of the present invention includes the vertical stand mode and the frame stand mode, and demands of the frictional torque are different for different modes. For example, the frictional torque of the first hinge module 60 can be adjusted by the first frictional torque control washer 70 and the second frictional torque control washer 72. When the display 52 is in the vertical stand mode shown in FIG. 3, the first protruding portion 701 of the first frictional torque control washer 70 contacts the second protruding portion 721 of the second frictional torque control washer 72 for increasing a normal friction between the first frictional torque control washer 70 and the second frictional torque control washer 72, so that the display positioning mechanism 56 provides greater frictional moment in the vertical stand mode. When the display 52 is in the frame stand mode shown in FIG. 4, the first protruding portion 701 of the first frictional torque control washer 70 does not contact the second protruding portion 721 of the second frictional torque control washer 72 for decreasing the normal friction between the first frictional torque control washer 70 and the second frictional torque control washer 72, so that the display positioning mechanism 56 provides smaller frictional moment in the frame stand mode. The display positioning mechanism 56 corresponds to an actual demand that the hinge module provides greater frictional moment in the vertical stand mode and provides smaller frictional moment in the frame stand mode. Furthermore, magnitude of the frictional moment can be controlled by a thickness of the separated washer 74.

As mentioned above, the display positioning mechanism 56 of the present invention integrates the hinge mechanisms with two specifications, which means the first hinge module 60 and the second hinge module 84 are suitable to be utilized in the vertical stand mode and in the frame stand mode, respectively, and the above-mentioned structural design is the most different point from the conventional hinge mechanism having the same torsional springs on two sides of the base. Besides, the present invention can overcome the drawback that the torques generated by two torsional springs may be counteracted with each other when the two torsional springs are in opposite directions. For example, when the display device 50 is in the vertical stand mode, the first hinge module 60 suitable to the vertical stand mode can provide the torque to the display 52, and the second hinge mode 60 suitable to the frame stand mode does not provide the torque to the display 52. On the other hand, when the display device 50 is in the frame stand mode, the second hinge module 84 suitable to the frame stand mode can provide the torque to the display 52, and the first hinge module 60 suitable to the vertical stand module does not provide the torque to the display 52.

Furthermore, the present invention fixes the fixing end 761 of the first loading component 76 and the fixing end 881 of the second loading component 88 on the first end 581 and the second end 582 of the supporting component 58, respectively, and disposes the movable end 762 of the first loading component 76 and the movable end 882 of the second loading component 88 on the first constraining structure 621 of the first preload control washer 62 and the second constraining structure 861 of the second preload control washer 86 in a slidable manner, respectively, so as to actuate one hinge module in one operational mode for providing a display positioning function, which means ends of the first loading component 76 and the second loading component 88 are the fixing ends, and the other ends of the first loading component 76 and the second loading component 88 are the movable ends. The present invention can further respectively form the first constraining structure 621 and the second constraining structure 861 on the first end 581 and the second end 582 of the supporting component 58, so that the fixing end 761 of the first loading component 76 and the fixing end 881 of the second loading component 88 are respectively fixed on the first preload control washer 62 and the second preload control washer 86, and the movable end 762 of the first loading component 76 and the movable end 882 of the second loading component 88 are respectively disposed on the first constraining structure 621 on the first end 581 of the supporting component 58 and the second constraining structure 861 on the second end 582 of the supporting component 58 in the slidable manner. Operational principle is the same as the above-mentioned embodiment, and detailed description is omitted herein for simplicity.

Comparing to the prior art, the display positioning mechanism and the display device of the present invention combines the vertical stand hinge and the frame stand hinge simultaneously, so that the display device can provide two operational modes, such as the vertical stand mode and the frame stand mode. Therefore, the present invention not only can increase the range of the positioning angle of the display, but also can provide various stand types to be switched.

Those skilled in the art will readily observe that numerous modifications and alterations of the device and method may be made while retaining the teachings of the invention.

What is claimed is:

1. A display positioning mechanism comprising:
a supporting component connected to a display and for supporting the display;
a first hinge module connected to a first end of the supporting component, the first hinge module comprising:
a first preload control washer whereon a first constraining structure is formed; and
a first loading component, a fixing end of the first loading component being fixed on the first end of the supporting component, the first loading component providing a torque in a first direction to the supporting component when an angle of the display and a supporting plate is within a first range, and the first loading component not providing the torque to the supporting component when the angle of the display and the supporting plane is within a second range different from the first range; and
a second hinge module connected to a second end of the supporting component, the second hinge module comprising:
a second preload control washer whereon a second constraining structure is formed; and
a second loading component, a fixing end of the second loading component being fixed on the second end of the supporting component, the second loading component not providing the torque to the supporting component when the angle of the display and the supporting plate is within the first range, and the second loading component providing a torque in a second direction opposite to the first direction to the supporting component when the angle of the display and the supporting plane is within the second range.

2. The display positioning mechanism of claim 1, wherein the first loading component and the second loading component are torsional springs, respectively.

3. The display positioning mechanism of claim 1, wherein the first hinge module further comprises a central axle passing through the first end of the supporting component, and the first preload control washer is sheathed on the central axle.

4. The display positioning mechanism of claim 3, wherein the first hinge module further comprises:
a first frictional torque control washer sheathed on the central axle, and a first protruding portion being formed on the first frictional torque control washer; and
a second frictional torque control washer sheathed on the central axle and fixed on the first end of the supporting component in a rotatable manner relative to the first frictional torque control washer, and a second protruding portion being formed on the second frictional torque control washer for contacting the first protruding portion when the angle of the display and the supporting plane is within the first range.

5. The display positioning mechanism of claim 4, wherein the first hinge module further comprises a separated washer sheathed on the central axle and installed between the first frictional torque control washer and the second frictional torque control washer so as to control a distance of the first frictional torque control washer and the second frictional torque control washer.

6. The display positioning mechanism of claim 4, wherein the first hinge module further comprises:
a sleeve sheathed on the central axle and contacting the second frictional torque control washer and the first preload control washer; and
an elastic washer sheathed on the central axle and installed on a side of the first preload control washer, and the second frictional torque control washer pushing the sleeve when the first protruding portion of the first frictional torque control washer contacts the second protruding portion of the second frictional torque control washer so that the first preload control washer contacts the elastic washer tightly.

7. The display positioning mechanism of claim 6, wherein the first loading component is preloaded and a movable end of the first loading component contacts against an end of the first constraining structure so as to provide the torque in the first direction to the supporting component, a movable end of the second loading component is disposed inside the second constraining structure and does not contact against an end of the second constraining structure so that the second loading component does not provide the torque to the supporting component when the angle of the display and the supporting plane is within the first range, the movable end of the first loading component is disposed inside the first constraining structure and does not contact against the end of the first constraining structure so that the first loading component does not provide the torque to the supporting component, and the second loading component is preloaded and the movable end of the second loading component contacts against the end of the second constraining structure so as to provide the torque in the second direction to the supporting component when the angle of the display and the supporting plane is within the second range.

8. The display positioning mechanism of claim 3, wherein the first hinge module further comprises:
a connecting plate for connecting to a base; and
at least one wear-resisting washer sheathed on the central axle and installed between the connecting plate and the first end of the supporting component for preventing the first end of the supporting component from being worn when the first end of the supporting component rotates relative to the connecting plate.

9. The display positioning mechanism of claim 1, wherein the first range is substantially between −5 degree and 20 degree, and the second range is substantially between 20 degree and 62 degree.

10. The display positioning mechanism of claim 1, wherein the first constraining structure and the second constraining structure are arc slots, respectively.

11. A display positioning mechanism comprising:
a supporting component connected to a display and for supporting the display, a first constraining structure and second constraining structure being respectively formed on a first end and a second end of the supporting component;
a first hinge module connected to the first end of the supporting component, the first hinge module comprising:
a first preload control washer; and
a first loading component, a fixing end of the first loading component being fixed on the first preload control washer, the first loading component providing a torque in a first direction to the supporting component when an angle of the display and a supporting plate is within a first range, and the first loading component not providing the torque to the supporting component when the angle of the display and the supporting plane is within a second range different from the first range; and
a second hinge module connected to the second end of the supporting component, the second hinge module comprising:
a second preload control washer; and
a second loading component, a fixing end of the second loading component being fixed on the second preload control washer, the second loading component not providing the torque to the supporting component when the angle of the display and the supporting plate is within the first range, and the second loading component providing a torque in a second direction opposite to the first direction to the supporting component when the angle of the display and the supporting plane is within the second range.

12. A display device comprising:
a display;
a base for supporting the display on a supporting plane; and
a display positioning mechanism connected to the display and the base for positioning the display on the supporting plane, the display positioning mechanism comprising:
a supporting component connected to the display for supporting the display;
a first hinge module connected to a first end of the supporting component, the first hinge module comprising:
a first preload control washer whereon a first constraining structure is formed; and
a first loading component, a fixing end of the first loading component being fixed on the first end of the supporting component, the first loading component providing a torque in a first direction to the supporting component when an angle of the display and the supporting plate is within a first range, and the first loading component not providing the torque to the supporting component when the angle of the display and the supporting plane is within a second range different from the first range; and
a second hinge module connected to a second end of the supporting component, the second hinge module comprising:
a second preload control washer whereon a second constraining structure is formed; and
a second loading component, a fixing end of the second loading component being fixed on the second end of the supporting component, the second loading component not providing the torque to the supporting component when the angle of the display and the supporting plate is within the first range, and the second loading component providing a torque in a second direction opposite to the first direction to the supporting component when the angle of the display and the supporting plane is within the second range.

13. The display device of claim 12, wherein the first hinge module further comprises a central axle passing through the first end of the supporting component, and the first preload control washer is sheathed on the central axle.

14. The display device of claim 13, wherein the first hinge module further comprises:
a first frictional torque control washer sheathed on the central axle, and a first protruding portion being formed on the first frictional torque control washer; and
a second frictional torque control washer sheathed on the central axle and fixed on the first end of the supporting component in a rotatable manner relative to the first frictional torque control washer, and a second protruding portion being formed on the second frictional torque control washer for contacting the first protruding portion when the angle of the display and the supporting plane is within the first range.

15. The display device of claim 14, wherein the first hinge module further comprises a separated washer sheathed on the central axle and installed between the first frictional torque control washer and the second frictional torque control washer so as to control a distance of the first frictional torque control washer and the second frictional torque control washer.

16. The display device of claim 14, wherein the first hinge module further comprises:
a sleeve sheathed on the central axle and contacting the second frictional torque control washer and the first preload control washer; and
an elastic washer sheathed on the central axle and installed on a side of the first preload control washer, and the second frictional torque control washer pushing the sleeve when the first protruding portion of the first frictional torque control washer contacts the second protruding portion of the second frictional torque control washer so that the first preload control washer contacts the elastic washer tightly.

17. The display device of claim 16, wherein the first loading component is preloaded and a movable end of the first loading component contacts against an end of the first constraining structure so as to provide the torque in the first direction to the supporting component, a movable end of the second loading component is disposed inside the second constraining structure and does not contact against an end of the second constraining structure so that the second loading component does not provide the torque to the supporting component when the angle of the display and the supporting plane is within the first range, the movable end of the first loading component is disposed inside the first constraining structure and does not contact against the end of the first constraining structure so that the first loading component does not provide the torque to the supporting component, and the second loading component is preloaded and the movable end of the second loading component contacts against the end of the second constraining structure so as to provide the torque in the second direction to the supporting component when the angle of the display and the supporting plane is within the second range.

18. The display device of claim 13, wherein the first hinge module further comprises:
a connecting plate for connecting to the base; and
at least one wear-resisting washer sheathed on the central axle and installed between the connecting plate and the first end of the supporting component for preventing the first end of the supporting component from being worn when the first end of the supporting component rotates relative to the connecting plate.

19. The display device of claim 12, wherein the first range is substantially between −5 degree and 20 degree, and the second range is substantially between 20 degree and 62 degree.

20. A display device comprising:
a display;
a base for supporting the display on a supporting plane; and
a display positioning mechanism connected to the display and the base for positioning the display on the supporting plane, the display positioning mechanism comprising:
a supporting component connected to the display for supporting the display, a first constraining structure and second constraining structure being respectively formed on a first end and a second end of the supporting component;
a first hinge module connected to the first end of the supporting component, the first hinge module comprising:
a first preload control washer; and
a first loading component, a fixing end of the first loading component being fixed on the first preload control washer, the first loading component providing a torque in a first direction to the supporting component when an angle of the display and the supporting plate is within a first range, and the first loading component not providing the torque to the supporting component when the angle of the display and the supporting plane is within a second range different from the first range; and
a second hinge module connected to a second end of the supporting component, the second hinge module comprising:
a second preload control washer; and
a second loading component, a fixing end of the second loading component being fixed on the second preload control washer, the second loading component not providing the torque to the supporting component when the angle of the display and the supporting plate is within the first range, and the second loading component providing a torque in a second direction opposite to the first direction to the supporting component when the angle of the display and the supporting plane is within the second range.
